(19) United States
(12) Patent Application Publication
(10) Pub. No.: US 2002/0181563 A1
(43) Pub. Date: Dec. 5, 2002

(54) Spread spectrum receiver and method of detection

(75) Inventor: Kenneth R. Whight, Horsham (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/134,167

(22) Filed: Apr. 26, 2002

(30) Foreign Application Priority Data
Apr. 28, 2001 (GB) 0110465.2

(51) Int. Cl. H04K 1/00

(52) U.S. Cl. 375/152

(57) ABSTRACT

A method of detecting, and a receiver for, a spread spectrum signal, in which a chip sequence is sampled (110) and filtered in a matched filter (120), the output of the filter is averaged (130) over respective samples of successive chip sequences, and the position of the chip sequence in the spread spectrum signal is determined (170) by determining the position of closest match between the averaged filter output and samples taken at the same interval from a reference correlation function of the chip sequence. The time of arrival of the spread spectrum signal may be determined by comparison of the position of the chip sequence, or an average of more than one such position, with a time reference. The position of closest match may be determined by a least squares fit technique.

The present invention relates to a method of detecting a spread spectrum signal and to a receiver for a spread spectrum signal, and has application in, for example, apparatus for estimating the time of arrival of a signal, apparatus for estimating the distance travelled by signal from a transmitter to a receiver, and in location determining apparatus.

It is known to detect a spread spectrum chip sequence by correlating a received signal with a reference signal, the peak of the correlation function indicating detection of the sequence. Typically, the detection is performed using samples of the received signal and of the reference signal. Due to sampling, the maximum resolution for determining the position of the sequence in the received signal has been ±0.5 sample interval. For example, a sequence transmitted at a chip rate of 2.2 Mchip.s⁻¹ and sampled in the receiver at 22 Msample.s⁻¹ would give a detection resolution of ±0.5/22 10⁻⁶=+2.27 10⁻⁸ seconds. If such a detection process is used for calculating the signal propagation time from the transmitter to the receiver, the accuracy of the propagation time calculation is ±2.27 10⁻⁸ seconds. Furthermore, if such a calculated propagation time is used for calculating the distance travelled by the signal from the transmitter to the receiver, the accuracy of the distance calculation is ±c×2.27 10⁻⁸, where c is the speed of light, approximately 3.10⁸ m.s⁻¹. Therefore the resulting distance resolution is ±6.81 m.

A higher resolution can be achieved by increasing the sampling rate, but at the expense of increased power consumption and complexity. A higher resolution can also be obtained by averaging over measurements made on several occurrences of the chip sequence in the received signal, but at the expense of increased power consumption and increased time delay. In some applications, for example in portable range determining apparatus and portable location determining apparatus for use in an indoor environment, it is desirable to have rapid detection with a high resolution and a low power consumption.

An object of the present invention is to provide improvements in the detection of a spread spectrum chip sequence.

According to one aspect of the invention there is provided a method of detecting a spread spectrum signal comprising a chip sequence, comprising sampling at a sampling interval a received signal, filtering in a matched filter the samples thereby obtained, determining the absolute values of the filtered samples, deriving the weighted average values of the absolute values of the filtered samples occurring at intervals equal to the chip sequence length, the weighted average values being calculated over at least two such absolute values, and determining the position of the chip sequence in the received signal by determining the position of closest match between the weighted average values and samples taken at the sampling interval from a reference correlation function of the chip sequence.

According to another aspect of the invention there is provided a receiver for a spread spectrum signal comprising a chip sequence, comprising sampling means for sampling at a sampling interval a received signal, matched filtering means for filtering the samples thereby obtained, modulus means for determining the absolute values of the filtered samples, averaging means for calculating the weighted average values of the absolute values of the filtered samples occurring at intervals equal to the chip sequence length, the weighted average values being calculated over at least two such absolute values, and matching means for determining the position of the chip sequence in the received signal by determining the position of closest match between the weighted average values and samples taken at the sampling interval from a reference correlation function of the chip sequence.

By deriving the weighted average values of the absolute values of the filtered samples the impact of noise is averaged, and in determining the position of closest match between the weighted average values and the samples of the reference correlation function the timing of the weighted average values and the samples of the reference correlation function are not constrained to be coincident but may vary independently. In this way, the position of closest match may be determined in which the samples of the reference correlation function and the weighted average values are offset from each other in time. Therefore a higher, sub-sample resolution may be achieved. The higher resolution is obtained without requiring an analogue-to-digital sampling circuit to operated at an increased sampling rate, thereby avoiding the higher power consumption and increased complexity of such a sampling circuit.

The position of closest match between the weighted average values and the samples of the reference correlation function of the chip sequence may be determined by performing a least squares fit of the weighted average values and the samples of the reference correlation function of the chip sequence. In performing the least squares fit, a free parameter is the time offset between the weighted average values and the samples of the reference correlation function. The peak value of the reference correlation function may also be a free parameter.

The determination of the position of closest match between the weighted average values and samples of the reference correlation function of the chip sequence may be performed over a period shorter than the chip sequence length, for example being performed only in the vicinity of a peak in the weighted average values, thereby avoiding the higher power consumption and circuit complexity of matching over the duration of a complete chip sequence.

The time of arrival of the spread spectrum signal may be determined as the determined position of the chip sequence in the received signal relative to a time reference.

The time of arrival of the spread spectrum signal may be determined as the average of more than one determined position of the chip sequence in the received signal relative to a time reference.

The time taken for a radio signal to propagate between the transmitter and receiver may be determined from the time of arrival if the transmitter and receiver have synchronised time references.

The distance between the transmitter and receiver may be determined from the time taken for a radio signal to propagate between the transmitter and receiver.

In one embodiment of the invention the weighted average values of the absolute values of the filtered samples are calculated in accordance with the equation:

\hat{χ}ᵢⁿ=α·\hat{χ}ᵢⁿ⁻¹+(1−α)·\hat{χ}ᵢⁿ

where \hat{χ}ᵢⁿ is the absolute value of the ith filtered sample in the nth chip sequence,

\hat{χ}ᵢⁿ is the weighted average value of the absolute value of the ith filtered sample in the nth chip sequence,

\hat{χ}ᵢⁿ⁻¹ is the weighted average value of the absolute value of the ith filtered sample in the n-l th chip sequence, and

α is the averaging gain and has a value in the range 0≦α≦1.

The invention will now be described, by way of example, with reference to the accompanying drawings, wherein:

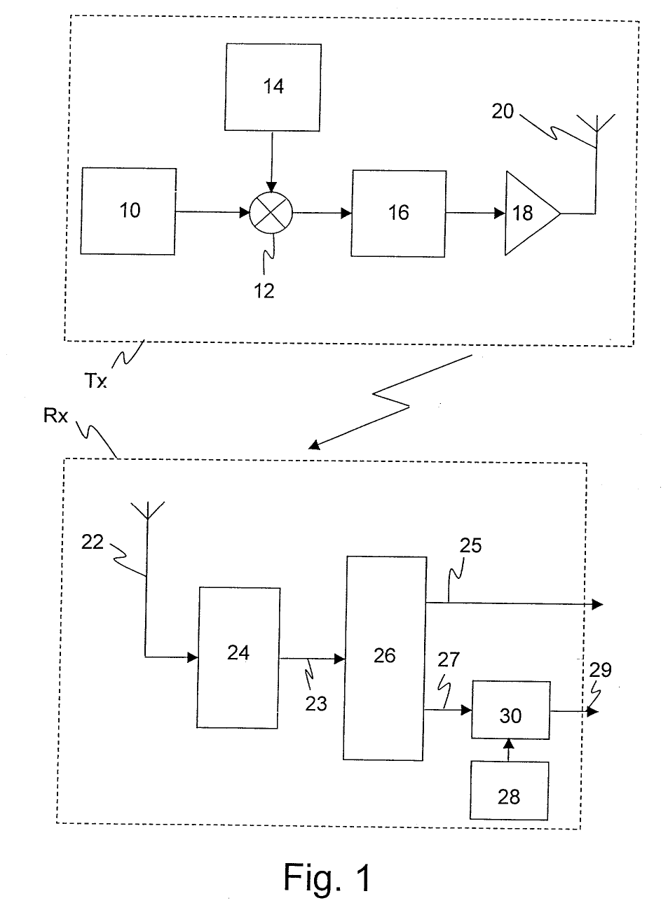

FIG. 1 is a block schematic diagram of an embodiment of a spread spectrum system,

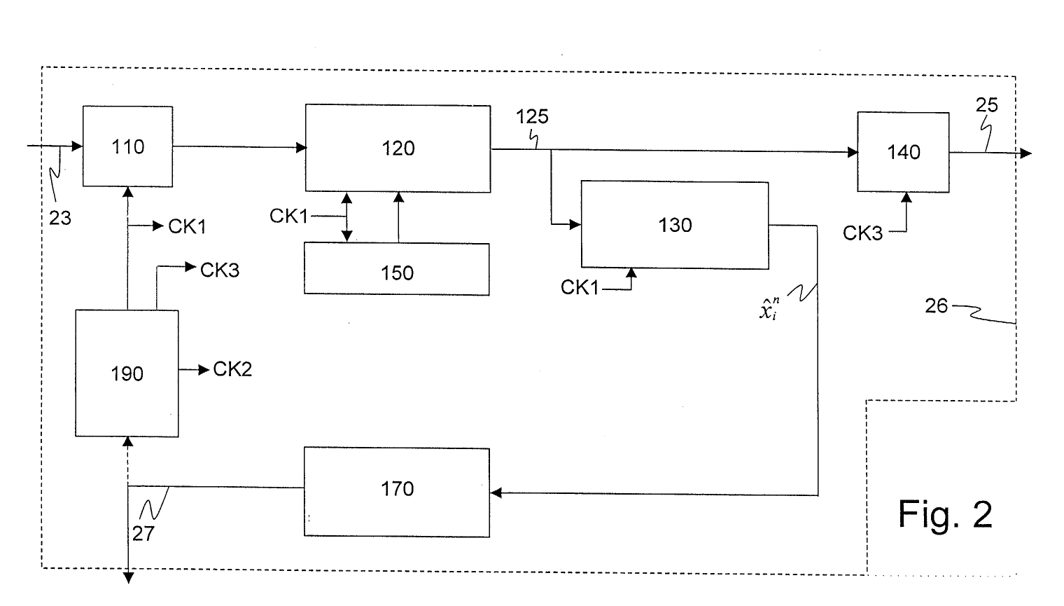

FIG. 2 is a block schematic diagram of a baseband processing section of a spread spectrum receiver,

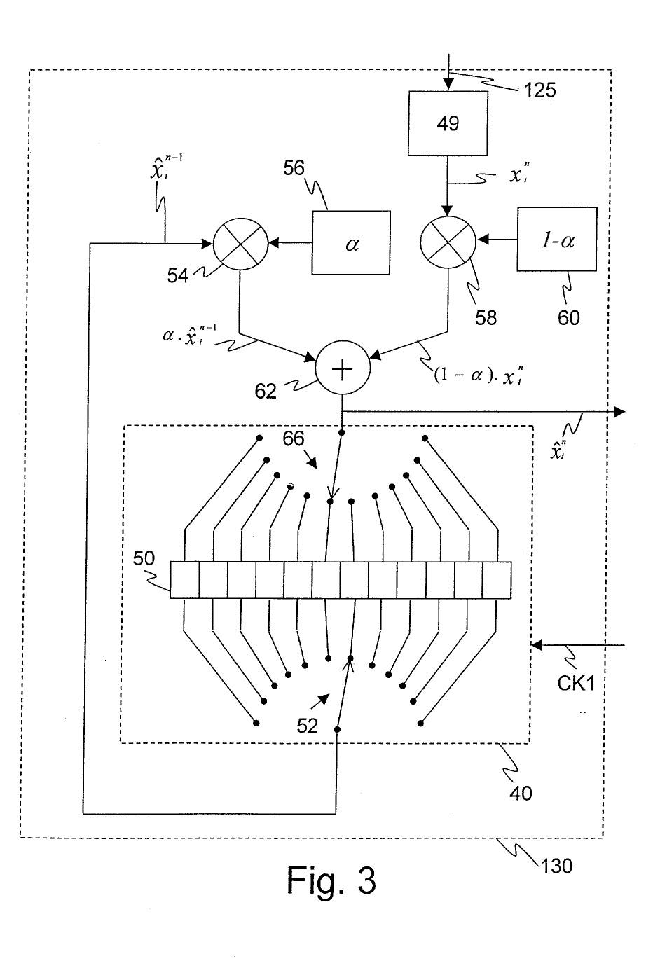

FIG. 3 is a block schematic diagram of an averaging circuit,

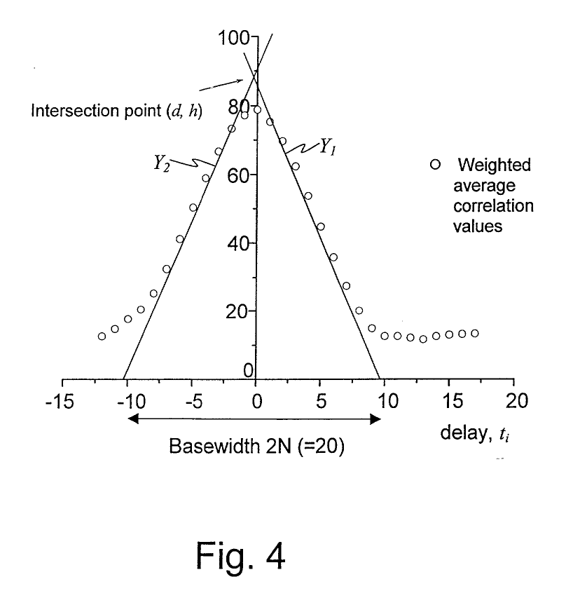

FIG. 4 illustrates least squares fitting,

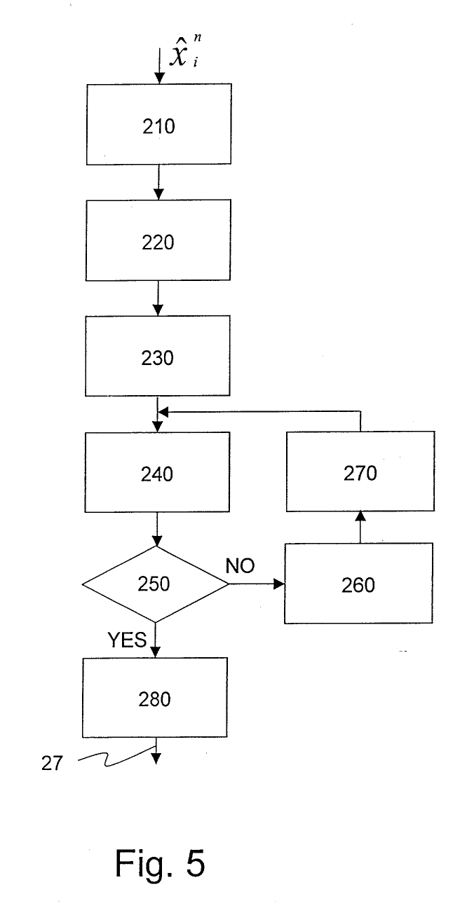

FIG. 5 is a flow chart of least squares fitting, and

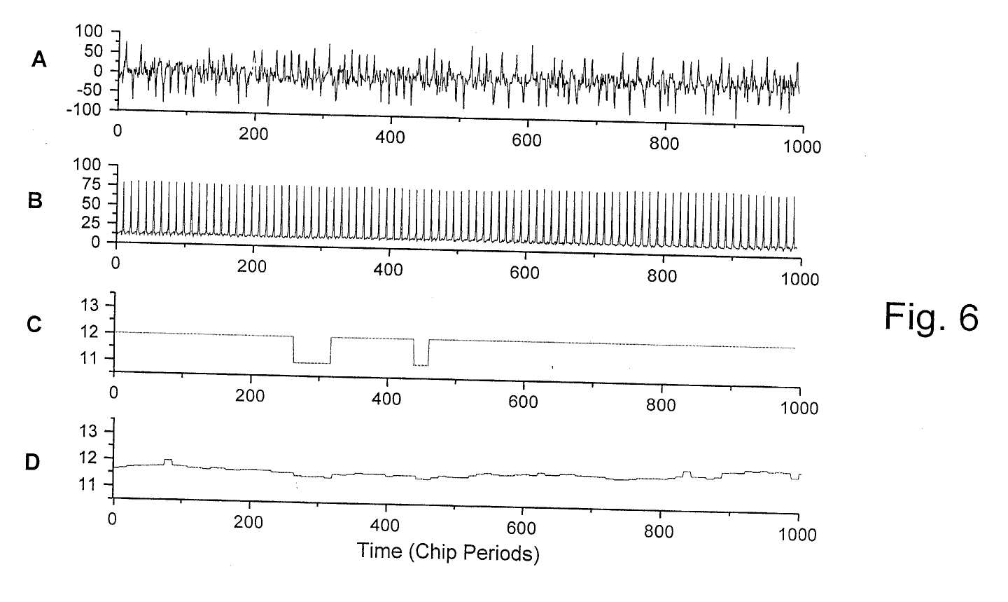

FIG. 6 shows graphs of signals within a spread spectrum receiver.

In the drawings the same reference numerals have been used to represent corresponding features.

Referring to FIG. 1, the spread spectrum system comprises a transmitter Tx and a receiver Rx. The system uses a C chip P-N (psuedo-noise) sequence for spreading. For convenience of description it will be assumed that the system operates in the 2.4 GHz ISM band with a bit rate of 200 kbit.s⁻¹, with the signal spread to 2.2 MHz using a sequence of 11 chips (C=11) at a chip rate of 2.2 Mchip.s⁻¹. The transmitter Tx comprises a data source 10 which produces symbols in the form of bits at 200 kbit.s⁻¹. The symbols are supplied to a mixer 12 to which is connected a code generator 14 which supplies an 11 chip P-N sequence. The 2.2 MHz spread signal is supplied by the mixer 12 to a GFSK modulator 16, the output of which is a modulated radio signal which is amplified in a power amplifier 18 and propagated by an antenna 20. In the course of being propagated the radio signal will be subject to noise and distortion.

At the receiver Rx, the propagated radio signal is received by an antenna 22 and is passed to an RF front end and demodulator 24. An output 23 of the RF front end and demodulator 24 is coupled to a baseband processing section 26 which is described in detail below. There are two outputs from the baseband processing section 26. The first output 25 supplies an indication of the value of a received symbol. The second output 27 supplies an indication of the position of the chip sequence in the received signal and is coupled to a first input of a delay determining means 30. The delay determining means 30 also receives a time reference signal from a time reference source 28. The delay determining means 30 determines the time difference between the time reference signal and the indication of the position of the chip sequence in the received signal. This time difference represents the time of arrival of the received signal relative to the time reference, and an indication of this time of arrival is supplied on an output 29.

Referring to FIG. 2 there is shown a block schematic diagram of the baseband processing section 26 of the receiver Rx. The signal delivered by the RF front end and demodulator 24 is coupled to a 1-bit analogue-to-digital converter (ADC) 110 which samples the received signal at a rate of N samples per chip, generating samples having a value of +1 or −1. For illustration, we use the example of N=10, in which case the ADC 110 delivers 22 Msample.s⁻¹. For the purpose of sampling, a sample rate clock CK1 is supplied to the ADC 110 by a clock generator 190. The samples from the ADC 110 are delivered to a matched filter which is matched to the chip sequence. The matched filter comprises a correlator 120 which performs a correlation of the samples of the received signal with samples of a reference chip sequence supplied to the correlator 120 by a reference sample generator 150. For the purpose of generating the reference samples, the reference sample generator 150 is supplied with the sample rate clock CK1 from the clock generator 190.

The correlator 120 is clocked by the sample rate clock CK1 and delivers on an output 125 correlation values at the rate of the sample clock CK1.

Because of the autocorrelation properties of the P-N sequence, the correlation value peaks, in the absence of noise and distortion, at the instant when the samples of the reference chip sequence generated by the reference sample generator 150 are synchronised with the samples of the received signal, and, furthermore, the sign of the peak will correspond to the value of the transmitted bit. However in the presence of noise or distortion, spurious peaks in the correlator 120 output can result in erroneous bit decisions. Furthermore, the position of the peak at this point in the receiver Rx, without further processing according to the invention, has a resolution of ±0.5 sample interval.

The impact of noise and distortion is reduced by supplying the correlation values delivered by the correlator 120 on the output 125 to an averaging circuit 130. The averaging circuit 130 computes for each sample the weighted average of the absolute value of the correlation values occurring at intervals of the chip sequence length. The computation is summarised by the following equation:

\hat{χ}ᵢⁿ=α·\hat{χ}ᵢⁿ⁻¹+(1−α)·\hat{χ}ᵢⁿ for i=1 to C.N

where \hat{χ}ᵢⁿ is the ith weighted average value of the correlation value of the nth chip sequence,

χᵢⁿis the absolute value of the ith correlation value in the nth chip sequence,

\hat{χ}ᵢⁿ⁻¹ is the ith weighted average value in the range of the correlation value of the n−1th chip sequence, and

α is the averaging gain and has a value 0≦α≦1. Typically α=0.5 for a simple average and a higher value closer to 1 for a system more resistant to the effects of noise and distortion.

Referring to FIG. 3, there is illustrated an implementation of the averaging circuit 130. A modulus means 49 delivers \hat{χ}ᵢⁿ, the absolute value of each correlation value, to a first input of a first multiplier 58. A second input of the first multiplier 58 is supplied with a constant 1−α which is held in a first store 60, and the first multiplier 58 delivers the product (1⊕α)·\hat{χ}ᵢⁿ to the first input of a first summing stage 62. A second input of the first summing stage 62 is supplied with the product α·\hat{χ}ᵢⁿ⁻¹ from a second multiplier 54 which is supplied at a first input with a constant a which is held in a second store 56 and with \hat{χ}ᵢⁿ⁻¹ at a second input. The generation of \hat{χ}ᵢⁿ⁻¹ is explained below. The first summing stage 62 delivers the sum α·\hat{χ}ᵢⁿ⁻¹+(1−α)·\hat{χ}ᵢⁿ, which is a weighted average correlation value.

For the generation of \hat{χ}ᵢⁿ⁻¹ there is multiplexer-demultiplexer 40 comprising a multistage store 50, a multiplexing arrangement 66 and a demultiplexing arrangement 52. The multistage store 50 is coupled to the output of the first summing stage 62 by means of the multiplexing arrangement 66. The multistage store 50 comprises C.N+1 stages (which in the present embodiment is 11.10+1=111 stages) for storing each of the C.N weighted average correlation values corresponding to the C.N samples comprising a chip sequence duration plus one value additional. Each value is entered into its respective stage of the multistage store 50 by the multiplexing arrangement 66. Each stage of the multistage store 50 is coupled to the demultiplexing arrangement 52 so that each stored value can be read-out in succession and applied to a second input of the second multiplier 54. The demultiplexing arrangement 52 is arranged to read out the corresponding ith weighted average correlation value of the previous chip sequence. The multiplexing and demultiplexing within the multiplexer-demultiplexer 40 is synchronised to the sample rate clock CK1.

Referring again to FIG. 2, observation of the output of the averaging circuit 130 would enable a peak in the correlation values output by the correlator 120 to be detected with a time resolution of ±0.5 sample interval. However, according to the invention, additional processing is provided to obtain a higher resolution, as follows. The weighted average correlation values \hat{χ}ᵢⁿ, i=1 to C.N, computed by the averaging circuit 130 are supplied to a matching circuit 170 which determines the position of closest match between these values and samples taken at the sampling interval from a reference correlation function of the chip sequence by performing a least squares fit. The matching circuit 170 may be implemented, for example, in a processor.

Referring to FIG. 4, the abscissa represents time in units of the sample interval, and the small circles represent the weighted average values of the absolute values of the filtered samples of the received signal and are spaced alone the abscissa by the sample interval. The origin (zero) of the abscissa has been selected to coincide with the peak average value. The lines Y₁ and Y₂ represent the reference correlation function of the chip sequence under conditions of no noise or distortion and which falls to zero one chip (10 samples) either side of the peak in the reference correlation function. The lines Y₁ and Y₂ are illustrated aligned with the weighted average values and intersect each other at the point (d, h) where d is the delay between the peak weighted average value and the peak of the reference correlation function, and h is the height of the reference correlation function. Values for d and h are determined by performing a least squares fit of the pair of lines Y₁ and Y₂ with the weighted average values, with d and h as free parameters. The least squares fit need be performed only in the vicinity of the peaks. In the present embodiment the least squares fit is performed over ±1 chip each side of the peak weighted average value.

The lines Y₁ and Y₂ are represented by the following equations:

$$\begin{matrix}{Y}_{1} = h ( 1 + \frac{t - d}{N} ) & ( Eqn . 1 ) \\ {Y}_{2} = h ( 1 - \frac{t - d}{N} ) & ( Eqn . 2 )\end{matrix}$$

The weighted average values \hat{χ}ᵢⁿ occur at equally spaced intervals tᵢ where i=0, ±1, ±2 . . . ±N. Initially the peak weighted average value \hat{χ}₀ⁿ is identified, and then it is assumed that the intersection (d, h) occurs immediately after position \hat{χ}₋₁ⁿ or \hat{χ}₀ⁿ i.e the intersection occurs after point \hat{χ}_{I}ⁿ where I=−1 or 0.

The squared error S² representing the sum of the squared perpendicular distance of each weighted average value from the reference correlation function represented by the lines Y₁ and Y₂ is:

$${S}^{2} = \frac{{h}^{2}}{{h}^{2} + {N}^{2}} \{ {\sum }_{i = - m}^{I} {[ {\hat{x}}_{i}^{n} - {Y}_{1} ( {t}_{i} ) ]}^{2} + {\sum }_{i = I + 1}^{m} {[ {\hat{x}}_{i}^{n} - {Y}_{2} ( {t}_{i} ) ]}^{2} \} \qquad ( Eqn . 3 )$$

where m<N and encompasses the range of weighted average values included in the least squares fit. The matching circuit 170 performs a minimisation of the squared error S² with respect to the variables h and d. This is performed by using equation 3 differentiated with respect to each of h and d and setting each result to zero, and solving the resulting two nonlinear equations by means of Newton linearisation to obtain the optimal values of h and d. Differentiation of equation 3 with respect to h and setting the result to zero yields:

$$\begin{matrix}{F}_{1} ≡ \frac{{N}^{2} {S}^{2}}{{h}^{2}} - h G = 0 \\ where & ( Eqn . 4 ) \\ G ≡ {\sum }_{i = - m}^{I} [ {\hat{x}}_{i}^{n} - {Y}_{1} ( {t}_{i} ) ] [ 1 + \frac{{t}_{i} - d}{N} ] + {\sum }_{i = I + 1}^{m} [ {\hat{x}}_{i}^{n} - {Y}_{2} ( {t}_{i} ) ] [ 1 - \frac{{t}_{i} - d}{N} ] & ( E q n . 5 )\end{matrix}$$

Differentiation of equation 3 with respect to d and setting the result to zero yields:

$${F}_{2} ≡ {\sum }_{i = - m}^{I} [ {\hat{x}}_{i}^{n} - {Y}_{1} ( {t}_{i} ) ] + {\sum }_{i = I + 1}^{m} [ {\hat{x}}_{i}^{n} - {Y}_{2} ( {t}_{i} ) ] = 0 \qquad ( Eqn . 6 )$$

Equations 4 and 6 are nonlinear in the variables h and d and are solved using the iterative Newton linearisation method for which the partial derivatives

$$\frac{\partial {F}_{1}}{\partial h} , \frac{\partial {F}_{1}}{\partial d} , \frac{\partial {F}_{2}}{\partial h} and \frac{\partial {F}_{2}}{\partial d}$$

are needed. These partial derivatives are:

$$\begin{matrix}\frac{\partial {F}_{1}}{\partial h} = \frac{2 N {F}_{1}}{h ( {h}^{2} + {N}^{2} )} - \frac{2 {N}^{2} {S}^{2}}{{h}^{3}} - G + h \{ {\sum }_{i = - m}^{I} {( 1 + \frac{{t}_{i} - d}{N} )}^{2} + {\sum }_{i = I + 1}^{m} {( 1 - \frac{{t}_{i} - d}{N} )}^{2} \} & ( Eqn . 7 ) \\ \frac{\partial {F}_{1}}{\partial d} = \frac{2 N h {F}_{2}}{{h}^{2} + {N}^{2}} + \frac{h}{N} \{ {\sum }_{i = - m}^{I} [ {\hat{x}}_{i}^{n} - 2 {Y}_{1} ] - {\sum }_{i = I + 1}^{m} [ {\hat{x}}_{i}^{n} - 2 {Y}_{2} ] \} & ( Eqn . 8 ) \\ \frac{\partial {F}_{2}}{\partial h} = {\sum }_{i = I + 1}^{m} ( 1 - \frac{{t}_{i} - d}{N} ) - {\sum }_{i = - m}^{I} ( 1 + \frac{{t}_{i} - d}{N} ) & ( Eqn . 9 ) \\ \frac{\partial {F}_{2}}{\partial d} = \frac{( 2 m + 1 ) h}{N} & ( Eqn . 10 )\end{matrix}$$

Initial estimates of the values of h and dare set respectively at \hat{χ}₀ⁿ and zero, and the functions F₁ and F₂ are calculated. The values of h and d are iteratively refined by repeatedly calculating corrections δh and δd to the values of h and d respectively using the following equations:

$$\begin{matrix}δ h = \frac{\frac{\partial {F}_{1}}{\partial d} {F}_{2} - \frac{\partial {F}_{2}}{\partial d} {F}_{1}}{D} & ( Eqn . 11 ) \\ δ d = \frac{\frac{\partial {F}_{2}}{\partial h} {F}_{1} - \frac{\partial {F}_{1}}{\partial h} {F}_{2}}{D} \\ where & ( E q n . 12 ) \\ D = \frac{\partial {F}_{1}}{\partial h} \frac{\partial {F}_{2}}{\partial d} - \frac{\partial {F}_{2}}{\partial h} \frac{\partial {F}_{1}}{\partial d} & ( E q n . 13 )\end{matrix}$$

Following correction of h and d according to the equations 11 and 12 the functions F₁ and F₂ are re-computed. The iterations are repeated until F₁ and F₂ are within a desired target values, for example 0.001.

The least squares fit performed by the matching circuit 170 and described above is illustrated in the flow chart of FIG. 5. The weighted average values \hat{χ}ᵢⁿ are received by the matching circuit 170 into block 210 of the flow chart. In block 210 the peak value of \hat{χ}ᵢⁿ determined and stored as \hat{χ}₀ⁿ. Then block 220 is executed in which the weighted average values \hat{χ}ᵢⁿ for i=±1, ±2 . . . ±N are stored. Then block 230 is executed in which initial estimates of h and d are set respectively to \hat{χ}₀ⁿ and zero. Then block 240 is executed in which the squared error S² is calculated using equation 3, and functions F₁ and F₂ are calculated using equations 4 and 6 respectively. Then block 250 is executed in which the values of F₁ and F₂ are compared with a desired target value, for example 0.001. If the values of F₁ and F₂ are not within the desired target value block 260 is executed in which the partial derivatives

$$\frac{\partial {F}_{1}}{\partial h} , \frac{\partial {F}_{1}}{\partial d} , \frac{\partial {F}_{2}}{\partial h} and \frac{\partial {F}_{2}}{\partial d}$$

are calculated using equations 7, 8, 9, and 10 and values of δh and δd are calculated using equations 11 and 12. Then block 270 is executed in which the estimates of h and dare modified by adding δh and δd to h and d respectively. The modified values of h and dare supplied to block 240 where S², F₁ and F₂ are recalculated. Then the values of F₁ and F₂ are compared again with the desired target value.

The values of h and dare modified iteratively until the values of F₁ and F₂ are within the desired target value, and then block 280 is executed in which an indication of the position of the chip sequence in the received signal is generated on the output 27. Processing of this position indication within the receiver Rx has been described above.

In addition, the position indication may, optionally, be delivered to the clock generator 190 (in FIG. 2) where it is used to synchronise the clock signals CK1, CK2 and CK3 (described below) to the received chip sequence.

The clock generator 190 generates a symbol clock CK3 at the symbol rate (which in the present embodiment is 200 kbit.s⁻¹). The symbol clock CK3 is supplied to a decision stage 140. The correlation values delivered by the correlator 120 are also delivered to the decision stage 140. The decision stage 140 stores the correlation value current at a time determined by the symbol clock CK3 and this value is delivered on the output 25 as the received bit soft decision value. Alternatively, the decision stage 140 stores the correlation value current at a time determined by the maximum value of \hat{χ}ᵢⁿ in each received chip sequence and this correlation value is delivered on the output 25 as the received bit soft decision value. Optionally, a hard decision value can be delivered by quantising the current correlation value.

Referring to the graphs of FIG. 6, the abscissae represent time in chip periods, and the full scale of 1000 chip periods corresponds to 1000/11=90.9 sequences each of 11 chips.

Trace A of FIG. 6 shows the correlation values obtained at the output of the sample correlator 120 under conditions of a 3 dB signal to noise ratio in the received signal and a sampling rate of N=10 samples per chip. Under noise free conditions peaks in the correlation values would occur once every sequence, whereas the peaks in trace A are distorted and partially obscured by the noise.

Trace B of FIG. 6 shows the weighted average correlation values obtained at the output of the averaging circuit 130 with an averaging gain α=0.975. It can be observed that the averaging process has smoothed the effect of noise thereby making the peaks in the weighted average correlation values distinct.

Trace C of FIG. 6 shows the position of the chip sequence in the received signal that would be indicated by the position of the peaks in the weighted average correlation values of trace B (i.e. without using the least squares fit). It can be observed that, due to noise, the indicated chip sequence position varies by one sample interval (4.54 108 s), varying between values of 11 and 12 samples. So a single position indication is accurate to only ±0.5 of a sample interval i.e ±2.27 10⁻⁸ s. Greater accuracy can be obtained by averaging over position indications, at the expense of increased processing power and time delay, but the averaging period required to obtain a particular accuracy is dependent on the level of noise in the receiver, and the required averaging period increases for very low levels of noise and for very high levels of noise. With no noise in the receiver the chip position indication may be in error by ±0.5 of a sample interval because there is no noise causing a variation between different values which can be averaged. For example, if the true chip sequence position is at 11.6 samples, with no noise the indicated chip position would be quantised to a value of 12, thereby introducing an error of 0.4 of a sample interval.

Trace D of FIG. 6 shows the position of the chip sequence in the received signal that is indicated by the indication generated at the output 27 of the matching circuit 170 and which indicates the position of closest match between the weighted average values and the samples of the reference correlation function of the chip sequence. It can be observed that by using the least squares fit technique, the detection resolution has been increased to less than a sample interval. Noise causes a variation in the indicated position of the chip sequence, but the averaging period required to obtain a particular accuracy is smaller than in trace C.

Optionally, the time of arrival supplied on the output 29 of the delay determining means may comprise an average derived from more than one occurrence of the chip sequence in the received signal of the time difference between the time reference signal and the indication of the position of the chip sequence in the received signal. By averaging in this way, greater resolution may be obtained. For example, by averaging over the 1000 chip periods depicted in trace D of FIG. 6, the average position of the chip sequence is 11.76 with a variance of 0.04 sample periods. The corresponding average if the least squares fit had not been used, but only single sample resolution, to determine the time difference between the time reference signal and the indication of the position of the chip sequence in the received signal would have been 11.92 with a variance of 0.07 samples.

Optionally, the matching circuit 170 may employ alternative known mathematical methods for determining the position of closest match between the weighted average values and the samples of the reference correlation function of the chip sequence.

Optionally, the least squares fit may be performed with h as a fixed parameter.

1. A method of detecting a spread spectrum signal comprising a chip sequence, comprising sampling at a sampling interval a received signal, filtering in a matched filter the samples thereby obtained, determining the absolute values of the filtered samples, deriving the weighted average values of the absolute values of the filtered samples occurring at intervals equal to the chip sequence length, the weighted average values being calculated over at least two such absolute values, and determining the position of the chip sequence in the received signal by determining the position of closest match between the weighted average values and samples taken at the sampling interval from a reference correlation function of the chip sequence.

2. A method as claimed in claim 1, wherein the position of closest match between the weighted average values and the samples of the reference correlation function of the chip sequence is determined by performing over a period of at least a portion of the chip sequence a least squares fit of the weighted average values with the samples of the reference correlation function of the chip sequence.

3. A method as claimed in claim 2, wherein the least squares fit is performed with time offset between the weighted average values and the samples of the reference correlation function as a free parameter.

4. A method as claimed in claim 3, wherein the least squares fit is performed with a peak value of the reference correlation function as a free parameter.

5. A method as claimed in any one of claims 1 to 4, wherein the weighted average values of the absolute values of the filtered samples are calculated in accordance with the equation:
\hat{χ}ᵢⁿ=α·\hat{χ}ᵢⁿ⁻¹+(1−α)·\hat{χ}ᵢⁿ
where \hat{χ}ᵢⁿ is the absolute value of the ith filtered sample in the nth chip sequence,
\hat{χ}ᵢⁿ⁻¹ is the weighted average value of the absolute value of the ith filtered sample in the nth chip sequence,
\hat{χ}ᵢⁿ⁻¹ is the weighted average value of the absolute value of the ith filtered sample in the n−1th chip sequence, and
α is the averaging gain and has a value in the range 0≦α≦1.

6. A method as claimed in any of claims 1 to 5, comprising determining the time of arrival of the spread spectrum signal as the determined position of the chip sequence in the received signal relative to a time reference.

7. A method as claimed in any of claims 1 to 5, comprising determining the time of arrival of the spread spectrum signal as the average of more than one determined position of the chip sequence in the received signal relative to a time reference.

8. A receiver for a spread spectrum signal comprising a chip sequence, comprising sampling means for sampling at a sampling interval a received signal, matched filtering means for filtering the samples thereby obtained, modulus means for determining the absolute values of the filtered samples, averaging means for calculating the weighted average values of the absolute values of the filtered samples occurring at intervals equal to the chip sequence length, the weighted average values being calculated over at least two such absolute values, and matching means for determining the position of the chip sequence in the received signal by determining the position of closest match between the weighted average values and samples taken at the sampling interval from a reference correlation function of the chip sequence.

9. A receiver as claimed in claim 8, wherein the matching means comprises means for performing over a period of at least a portion of the chip sequence a least squares fit of the weighted average values with the samples of the reference correlation function of the chip sequence.

10. A receiver as claimed in claim 9, wherein the least squares fit is performed with time offset between the weighted average values and the samples of the reference correlation function as a free parameter.

11. A receiver as claimed in claim 10, wherein the least squares fit is performed with a peak value of the reference correlation function as a free parameter.

12. A receiver as claimed in any of claims 8 to 11, wherein the weighted average values of the absolute values of the filtered samples are calculated in accordance with the equation:
\hat{χ}ᵢⁿ=α·\hat{χ}ᵢⁿ⁻¹+(1−α)·\hat{χ}ᵢⁿ
where \hat{χ}ᵢⁿ is the absolute value of the ith filtered sample in the nth chip sequence,
\hat{χ}ᵢⁿ is the weighted average value of the absolute value of the ith filtered sample in the nth chip sequence,
\hat{χ}ᵢⁿ⁻¹ is the weighted average value of the absolute value of the ith filtered sample in the n−1th chip sequence, and
α is the averaging gain and has a value in the range 0≦α≦1.

13. A receiver as claimed in any of claims 8 to 12, comprising delay determining means for determining the time of arrival of the spread spectrum signal as the determined position of the chip sequence in the received signal relative to a time reference.

14. A receiver as claimed in any of claims 8 to 12, comprising delay determining means for determining the time of arrival of the spread spectrum signal as the average of more than one determined position of the chip sequence in the received signal relative to a time reference.
